(19) United States
(12) Patent Application Publication
(10) Pub. No.: US 2009/0316650 A1
(43) Pub. Date: Dec. 24, 2009

(54) FAST HANDOVER METHOD USING L2/L3 COMBINATION

(75) Inventors: Tai Won UM, Seoul (KR); Won RYU, Daejeon (KR); Kang Woon HONG, Seoul (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/434,376

(22) Filed: May 1, 2009

(30) Foreign Application Priority Data
May 2, 2008 (KR) 10-2008-0041438
Apr. 10, 2009 (KR) 10-2009-0031256

(51) Int. Cl. H04W 72/00

(52) U.S. Cl. 370/331

(57) ABSTRACT

Provided is a fast handover method using a layer 2 (L2) and layer 3 (L3) combination. When a mobile node moves from a present region to another region, fast handover of the mobile node is provided using a location update function between handover control agents (HCAs), and data bicasting from an old HCA wherein the mobile node performs handover to a new HCA.

### CROSS-REFERENCE TO RELATED PATENT APPLICATION

This application claims the benefit of Korean Patent Application No. 10-2008-0041438, filed on May 2, 2008, and Korean Patent Application No. 10-2009-0031256, filed on Apr. 10, 2009, in the Korean Intellectual Property Office, the disclosures of which are incorporated herein in their entirety by reference.

### BACKGROUND OF THE INVENTION

1. Field of the Invention

The present invention relates to mobility support of a mobile node, and more particularly, to a fast handover method using a layer 2 (L2) and layer 3 (L3) combination.

2. Description of the Related Art

Generally, a mobile Internet protocol (MIP) of the internet engineering task force (IETF) is an example of a technology supporting mobility of a mobile node in a general Internet protocol (IP)-based network. Such a general technology is performed in a layer 3 (L3). In such an L3 mobility supporting technology, processes for the movement of a mobile node are performed in a layer 3 (L3) after processes at an L2 are completed. That is, the processes at the L3, such as address registration at a long range or registration to a location manager and a message transmission through L3 routing, are performed after performing the processes at the L2.

Thus, communication may not be performed during a delay time due to the above-described reasons. When the delay time increases, the communication maintained in a mobile node may be disconnected.

Recently, a proxy MIP technology, based on a MIP technology, supporting mobility to a node having no mobility supporting function has been suggested. However, the proxy MIP technology belongs to a general L3 mobility supporting technology such as the MIP technology.

### SUMMARY OF THE INVENTION

The present invention provides a fast handover method reducing a service interruption time and a data packet loss during handover of a mobile node by a mobility supporting method using a layer 2 (L2) and layer 3 (L3) combination.

According to an aspect of the present invention, there is provided a handover method in an apparatus for managing location information of a mobile node, the handover method including receiving a binding update request message; updating binding information of the mobile node by using a temporary location identifier that is newly assigned; and transmitting an acknowledgment in response to the binding update request message.

According to another aspect of the present invention, there is provided a handover method in a relaying apparatus of a mobile communication network, the handover method including if receiving notification of a layer 2 (L2) association with a mobile node, transmitting a binding update request message for the mobile node; if receiving an acknowledgment in response to the binding update request message, transmitting a tunnel update message regarding the mobile node; and receiving an acknowledgment in response to the tunnel update message.

According to another aspect of the present invention, there is provided a handover method in a relaying apparatus of a mobile communication network, the handover method including if recognizing a temporary location identifier regarding a correspondent node of the mobile node, transmitting a message regarding a change in an endpoint from a data tunnel towards the mobile node; and receiving an acknowledgment in response to the message.

According to another aspect of the present invention, there is provided a handover method in a relaying apparatus of a mobile communication network, the handover method including receiving a temporary location identifier of a correspondent node from an entity where a mobile node is previously located before the mobile node moves; transmitting a message regarding a change in an endpoint from a data tunnel towards the mobile node; and receiving an acknowledgment in response to the message.

According to another aspect of the present invention, there is provided a mobility supporting method of a mobile node when the mobile node performs handover from a first access network including a first handover control agent (HCA) to a second access network including a second HCA, in a system including handover control agents associating access networks with a core network, and a mobility information control system (MICS) located in the core network, the mobility supporting method including setting-up a tunnel towards the first HCA, based on an address of the first HCA of a message received from the MICS, wherein the setting-up is performed by the second HCA; setting-up a tunnel towards the second HCA, based on an address of the second HCA of a deregistration message received from the MICS, wherein the setting-up is performed by the first HCA; transmitting a location update message including an address of the mobile node and the address of the second HCA to a third HCA of a third access network to which a correspondent node belongs, wherein the transmitting is performed by the first HCA or the second HCA; changing tunnel information regarding the mobile node from the first HCA to the second HCA, wherein the changing is performed by the third HCA; and releasing a tunnel between the first HCA and the second HCA after a predetermined period of time by timeout.

According to another aspect of the present invention, there is provided a mobility supporting method of a mobile node when the mobile node performs handover from a first access network including a first handover control agent (HCA) to a second access network including a second HCA, in a system including handover control agents associating access networks with a core network, and a mobility information control system (MICS) located in the core network, the mobility supporting method including transmitting a location report message including an address of the mobile node, wherein the transmitting is performed by the second HCA; receiving a deregistration message including an address of the second HCA from the MICS, wherein the receiving is performed by the first HCA; if receiving a packet from a third HCA of a second access network to which a correspondent node belongs, transmitting a location update message including an address of the second HCA, wherein the transmitting is performed by the first HCA; and changing tunnel information regarding the mobile node from the first HCA to the second HCA, wherein the changing is performed by the third HCA.

According to another aspect of the present invention, there is provided a mobility supporting method of a mobile node, in a system including handover control agents associating access networks with a core network, and a mobility information control system (MICS) located in the core network, the mobility supporting method including setting-up a tunnel to a second handover control agent (HCA), wherein the setting-up is performed by a first HCA receiving a link going down message generated when the mobile node performs handover from a first access network including the first HCA to a second access network including the second HCA; forwarding a packet, received regarding the mobile node to the mobile node located in the first access network, to the mobile node located in the first access network, and forwarding the packet to the second HCA through the tunnel, wherein the forwarding is performed by the first HCA; forwarding the packet received from the tunnel to a point of attachment (PoA) of the second access network through the tunnel; and automatically releasing the tunnel after a predetermined period of time by timeout.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram for describing a method of controlling network-based handover, according to an embodiment.

FIG. 2 is a schematic diagram of a network structure in which a method according to an embodiment is embodied, according to an embodiment;

FIG. 3 is a flowchart of location registration and data transmission processes for supporting fast handover of a mobile node, according to an embodiment;

FIG. 4 is a flowchart of location registration and data transmission processes for supporting fast handover of a mobile node, according to another embodiment;

FIG. 5 is a flowchart of location registration and data transmission processes for supporting fast handover of a mobile node, according to another embodiment;

FIG. 6 is a flowchart of a fast handover method using data bicasting, according to an embodiment;

FIG. 7 is a flowchart of a fast handover method using data bicasting, according to an embodiment; and

FIG. 8 is a flowchart of a fast handover method using data bicasting, according to another embodiment.

### DETAILED DESCRIPTION OF THE INVENTION

Hereinafter, a method of providing mobility of a layer 2 (L2) and layer 3 (L3) combination will be described with regard to exemplary embodiments of the invention with reference to the attached drawings.

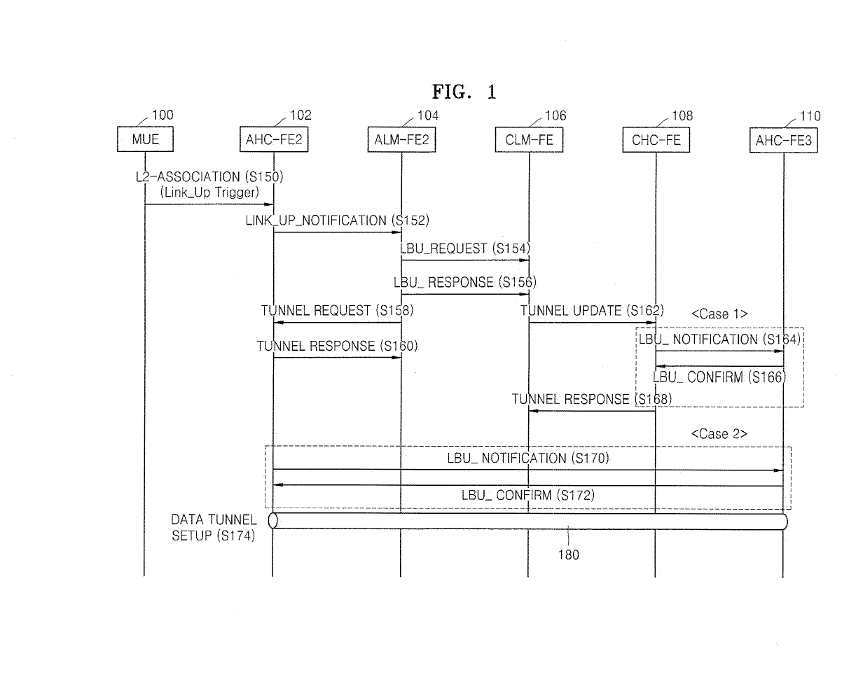

FIG. 1 is a diagram for describing a method of controlling network-based handover, according to an embodiment.

Referring to FIG. 1, logical functional entities for controlling handover include mobile user equipment (MUE) 100, an access handover control-functional entity 2 (AHC-FE2) 102, an AHC-FE3 110, an access location management-functional entity 2 (ALM-FE2) 104, a central location management-functional entity (CLM-FE) 106, and a central handover control-functional entity (CHC-FE) 108. The AHC-FE2 102, the AHC-FE3 110 and the ALM-FE2 104 are disposed in an access network, and the CHC-FE 108 and the CLM-FE 106 are disposed in a core network. However, the locations of the AHC-FE2 102, the AHC-FE3 110, the ALM-FE2 104, the CHC-FE 108 and the CLM-FE 106 are not limited to the access network or the core network, and thus the AHC-FE2 102, the AHC-FE3 110, the ALM-FE2 104, the CHC-FE 108 and the CLM-FE 106 may be located anywhere. In FIG. 1, the logical functional entities are classified according to their functions, for convenience of description. However, the logical functional entities may be embodied as apparatuses (e.g., servers, routers and relaying apparatuses) performing their respective functions, that is, as respective physical entities. In addition, two or more logical functional entities may be embodied as a single physical entity. A physical entity embodying a logical entity includes hardware for performing a function of the logical entity. For example, the physical entity embodying the logical entity includes hardware such as transceiver (a transceiver module for wireless communication in the case of wireless communication) receiving and transmitting a message, a processor analyzing a received message and controlling a function corresponding to the received message, and a memory for storing predetermined information.

According to the present embodiment, the MUE handovers from a region of an AHC-FE1 (not shown) to a region of the AHC-FE2 102. It is assumed that the AHC-FE3 110 currently controls an endpoint of a data tunnel 180, which is associated by correspondent user equipment (CUE) (not shown).

The MUE 100 moves to a region of the AHC-FE2 102 so as to perform an L2-association process with the AHC-FE2 102 (operation S150). That is, the MUE 100 transmits Link_Up Trigger to the AHC-FE2 102. The AHC-FE2 102 transmits a Link_Up_Notification messages to the ALM-FE2 104 (operation S152), and the ALM-FE2 104 transmits a location identifier (LID) binding update (LBU) request message (LBU request message) to the CLM-FE 106 (operation S154).

Before the CLM-FE 106 receives the LBU request message from the ALM-FE2 104, operations performed in a handover control (HC) process are the same as operations performed in a process for initial connection establishment of the MUE 100.

The CLM-FE 106 may recognize whether the LBU request message is to handle a handover situation or the initial connection establishment of the MUE 100, based on information included in the LBU request message. In the handover case, the CLM-FE 106 updates LID binding information of the MUE 100 with a temporary LID (TLID) that is newly assigned, and responds to the LBU request message by transmitting an LBU response message to the ALM-FE2 104 (operation S156). In this regard, the LID is largely classified into a Persistent LID (PLID) and a TLID. The PLID refers to an LID that is not changed when the MUE 100 moves to another access network or an Internet protocol (IP) subnet. The TLID refers to an LID that is changed when the MUE 100 moves to another access network or an IP subnet. Generally, an IP address is used as an LID, and LID binding updating is performed in order to manage mapping information between the PLID and the TLID.

When the CLM-FE 106 receives the LBU response message (operation S156), the ALM-FE2 104 and the AHC-FE2 102 exchange a tunnel request message and a tunnel response message in order to set up the end point of the data tunnel 180 for the MUE 100 (operations S158 and S160).

Data tunnel update operations with respect to the AHC-FE3 110 may be performed using any one of the two following methods.

CASE 1: It is assumed that the CHC-FE 108 may recognize a TLID of a CUE (not shown). The CHC-FE 108 transmits a LBU_notification message to the AHC-FE3 110 in order to notify the AHC-FE3 110 of a change in another endpoint of the data tunnel 180 (operation S164). An LBU_confirm message is used as a replay message (operation S166).

CASE 2: It is assumed that the AHC-FE2 102 may recognize a TLID of the CUE from an old AHC-FE (that is, the AHC-FE1). The AHC-FE2 102 transmits the LBU_notification message to the AHC-FE3 110 in order to notify the AHC-FE3 110 of a change in another endpoint of the data tunnel 180 (operation S170). An LBU_confirm message is used as a replay message (operation S172).

The method of controlling handover based on the logical functional entities has been described with reference to FIG. 1. Hereinafter, a network structure in which a method according to an embodiment is embodied, and a method of controlling handover through each physical entity in the network will be described. Of course, each of the logical functional entities of FIG. 1 may be embodied as any one or a plurality of physical entities that will be described.

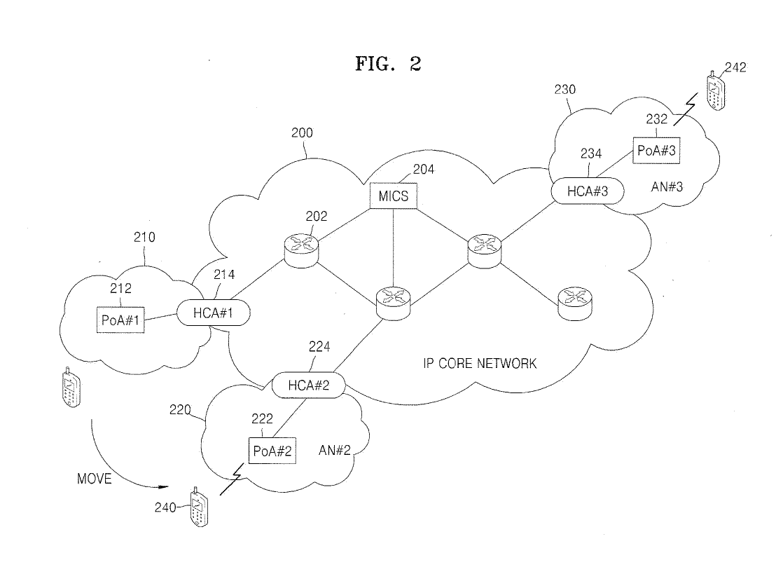

FIG. 2 is a schematic diagram of a network structure in which a method according to an embodiment is embodied, according to an embodiment.

Referring to FIG. 2, the network structure includes a core network 200 and access networks 210, 220 and 230. The core network 200 includes a mobility information control system (MICS) 204 and a core router 202. The access networks 210, 220 and 230 include points of attachment (POAs) #1, #2 and #3 212, 222 and 232, respectively, performing direct connection to a mobile node (MN) 240. Handover control agents (HCAs) #1, #2 and #3 214, 224 and 234 are positioned between the core network 200 and the access networks 210, 220 and 230, respectively.

The PoA #2 222 extracts a layer 2 (L2) address of the MN 240 through an L2-association process with the MN 240 and transmits the L2 address to the HCA #2 224 of a local region.

The HCA #2 224 receives the L2 address of the MN 240 from the PoA #2 222, maintains and manages the L2 address of the MN 240, transmits information regarding an address of the MN 240 and an address of the HCA #2 224 to the MICS 204, and encapsulates a data packet received from the MN 240.

The MICS 204 receives the information regarding the L2 and L3 addresses of the MN 240 from the HCA #2 224, and maintains and manages the information regarding the L2 and L3 addresses of the MN 240.

Signaling processes, for supporting the mobility of the MN 240, between the MICS 204 and the HCA #2 224, and between the HCA #1, #2 and #3 HCAs 214, 224 and 234 may be largely classified into “initial location registration and data transmission processes” and “location registration and data transmission processes after handover”.

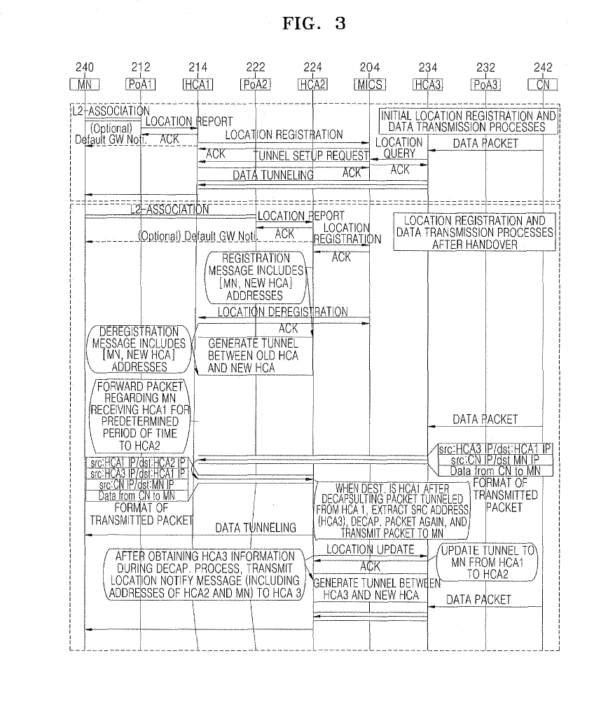

FIG. 3 is a flowchart of location registration and data transmission processes for supporting fast handover of a mobile node, according to an embodiment.

Referring to FIGS. 2 and 3, when the MN 240 is powered-on, or enters a mobility providing network using a layer 2 (L2) and layer 3 (L3) combination, according to the present embodiment, a L2-association process is performed between the MN 240 and the PoA #1 212.

The PoA #1 212 obtains the L2 address of the MN 240 (e.g., a media access control (MAC) address) during the L2-association process with the MN 240, and transmits a location report message including the L2 address of the MN 240 to the HCA #1 214.

The HCA #1 214 that receives the location report message transmits an acknowledgment to the PoA #1 212. The HCA #1 214 inserts the L2 address of the MN 240 into an MN binding table (MBT) included in the HCA #1 214, and transmits a location registration message to the MICS 204.

The MICS 204 extracts the L2 address of the MN 240, included in the location registration message, and stores the L2 address of the MN 240 together with an IP address of the HCA #1 214, included in a global binding table (GBT). The MICS 204 transmits an acknowledgment to the HCA #1 214 in response to the location registration message. During the initial registration, since the L3 address, that is an IP address of the MN 240 is not included in the GBT of the MICS 204, a MN IP address field of the acknowledgment in response to the location registration message transmitted from the MICS 204 to the HCA #1 214 is set as null.

The IP address of the MN 240 is assigned to the HCA #1 214 that receives the acknowledgment from the MICS 204 by using a dynamic host configuration protocol (DHCP), and then the HCA #1 214 transmits an address update message to the MICS 204. In addition, the MICS 204 records the IP address of the MN 240, included in the address update message, on the GBT of the MICS 204.

When a data packet from a corresponding node (CN) 242 arrives at the HCA #3 234 after the location registration of the MN 240 is performed, the HCA #3 234 extracts a destination IP address (i.e., the IP address of the MN 240) of the received packet, and transmits a location query message including the extracted IP address to the MICS 204.

When the MICS 204 receives the location query message, the MICS 204 searches the GBT of the MICS 204 so as to find the IP address of the HCA #1 214 of a region where the MN 240 is located, and transmits the IP address of the HCA #1 214 to the HCA #3 234 by using a location query acknowledgment.

The HCA #3 234 that receives the location query acknowledgment from the MICS 204 sets up a tunnel towards the HCA #1 214 by using the IP address of the MN 240 and the IP address of the HCA #1 214 which are included in the acknowledge.

After the MICS 204 transmits the location query acknowledgment to the HCA #3 234, the MICS 204 transmits the IP address of the HCA #3 234 and an IP address of the CN 242 to the HCA #1 214 that transmits the location registration message, by using a tunnel setup request message. Then, the HCA #3 234 generates a tunnel interface towards the HCA #1 214.

The HCA #3 234 sets up a tunnel to the HCA #1 214 of the region where the MN 240 is located, and then transmits the data packet from the CN 242 to the HCA #1 214 through the tunnel.

Next, the “location registration and data transmission process after handover” will be described.

After the handover, the MN 240 performs a L2-association process with the PoA #2 222, and the PoA #2 222 that obtains the L2 address of the MN 240 during the L2-association process transmits the location report message including the L2 address of the MN 240 to the HCA #2 224.

The HCA #2 224 that receives the location report message transmits a location report acknowledgment to the PoA #2 222, and transmits a location registration message to the MICS 204.

The MICS 204 that receives the location registration message from the HCA #2 224 searches the GBT of the MICS 204, changes a HCA IP address mapped to the L2 address of the MN 240 from the HCA #1 214 to the HCA #2 224, and transmits a location registration acknowledgment to the HCA #2 224. In this regard, the location registration acknowledgment includes the IP address of the MN 240 and the IP address of the HCA #1 214 of the region where the MN 240 is located prior to the handover.

The HCA #2 224 that receives the location registration acknowledgment from the MICS 204 sets up a tunnel towards the HCA #1 214 by using the IP address of the HCA #1 214 and the IP address of the MN 240, which are included in the location registration acknowledgment.

After transmitting the location registration acknowledgment to the HCA #2 224, the MICS 204 transmits to the HCA #1 214 the location deregistration message, including the IP address of the HCA #2 224 on which the MN 240 performs the handover.

When the HCA #1 214 receives the location deregistration message from the MICS 204, the HCA #1 214 sets up a tunnel towards the HCA #2 224 of a region where the MN 240 is presently located by using the IP address of the HCA #2 224 and the IP address of the MN 240, which are included in the location deregistration message, and transmits a location deregistration acknowledgment to the MICS 204.

When the data packet from the CN 242 arrives at the HCA #3 234, the HCA #3 234 performs IP-in-IP encapsulation on the data packet, and forwards the encapsulated data packet to the HCA #1 214 in which the tunnel interface with respect to the MN 240 is set up.

When the HCA #1 214 receives the data packet encapsulated, the HCA #1 214 decapsulates the data packet, and checks a destination address of the data packet. If it is determined that deregistration has already been performed on the MN 240 corresponding to the destination address of the data packet and that the MN 240 has moved to another HCA, the data packet received regarding the MN 240 is forwarded through a tunnel set up from the HCA #1 214 to the HCA #2 224. A format of the forwarded data packet is, for example, a format in which the encapsulated data packet received from the HCA #3 234 includes a header having an IP address of the HCA #2 224 as a destination IP address and an IP address of the HCA #1 214 as a transmitter IP address, as illustrated in FIG. 3.

When the HCA #2 224 receives the data packet through the tunnel, the HCA #2 224 decapsulates the data packet, and checks the destination IP address of the data packet. If the destination IP address of the data packet corresponds to a correspondent of the generated tunnel, that is, the HCA #1 214, the data packet is forwarded to the MN 240.

By decapsulating the data pocket received through the HCA #1 214 from the HCA #3 234, the HCA #2 224 may obtain the IP address of the HCA #3 234. The HCA #2 224 transmits a location update message including the IP address of the MN 240 and the IP address of the HCA #2 224 to the HCA #3 234 by using the obtained IP address of the HCA #3 234.

The HCA #3 234 that receives the location update message from the HCA #2 224 changes tunnel information regarding the MN 240 from the HCA #1 214 to the HCA #2 224, and then transmits the data packet received by the MN 240 by the tunnel between the HCA #1 214 and the HCA #2 224.

A tunnel between the HCA #1 214 and the HCA #2 224 is maintained for a predetermined period of time, and then is automatically released by timeout.

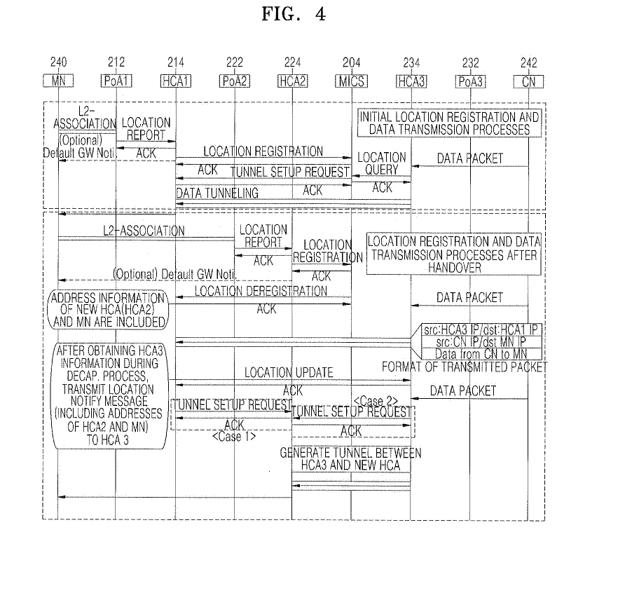

FIG. 4 is a flowchart of location registration and data transmission processes for supporting fast handover of a mobile node, according to another embodiment.

Referring to FIGS. 2 and 4, “initial location registration and data transmission processes” according to the present embodiment is the same as that of FIG. 2, and thus its detailed description will not be repeated. Hereinafter, “location registration and data transmission processes after handover” of the mobile node will be described.

After the handover, the MN 240 performs an L2-association process with the PoA #2 222, and the PoA #2 222 that obtains the L2 address of the MN 240 during the L-2 association process transmits the location report message including the L2 address of the MN 240 to the HCA #2 224.

The HCA #2 224 that receives the location report message from the PoA #2 222 transmits a location report acknowledgment to the PoA #2 222, and transmits a location registration message to the MICS 204.

The MICS 204 that receives the location registration message from the HCA #2 224 searches the GBT of the MICS 204, changes a HCA IP address mapped to the L2 address of the MN 240 from the HCA #1 214 to the HCA #2 224, and transmits a location registration acknowledgment to the HCA #2 224.

After transmitting the location registration acknowledgment to the HCA #2 224, the MICS 204 transmits to the HCA #1 214 a location deregistration message including the IP address of the HCA #2 224 on which the MN 240 performs the handover.

When the data packet from the CN 242 arrives at the HCA #3 234, the HCA #3 234 performs IP-in-IP encapsulation on the data packet, and forwards the data packet to the HCA #1 214 in which the tunnel interface with respect to the MN 240 is set up.

When the HCA #1 214 receives the data packet encapsulated by the HCA #3 234, the HCA #1 214 decapsulates the data packet, and checks a destination address of the data packet. If it is determined that deregistration has already been performed on the MN 240 corresponding to the destination address of the data packet and that the MN 240 has moved to the HCA #2 224, the HCA #1 214 transmits to the HCA #3 234 the registration update message including an address of the HCA #2 224, which is obtained during the deregistration process.

The HCA #3 234 that receives the location update message from the HCA #1 214 changes tunnel information regarding the MN 240 from the HCA #1 214 to the HCA #2 224, and then transmits the data packet regarding the MN 240, which is received after the change, to the HCA #2 224 by the tunnel.

After transmitting the location update message to the HCA #3 234, the HCA #1 214 transmits the tunnel setup request message including the IP address of the HCA #3 234 to the HCA #2 224 so as to request the HCA #2 224 to set up a tunnel towards the HCA #3 234 (CASE 1). Alternatively, after receiving the location update message, the HCA #3 234 recognizes an address of the HCA #2 224, included in the location update message, and transmits the tunnel setup request message to the HCA #2 224 so as to request the HCA #2 224 to set up a tunnel towards the HCA #3 234 (CASE 2).

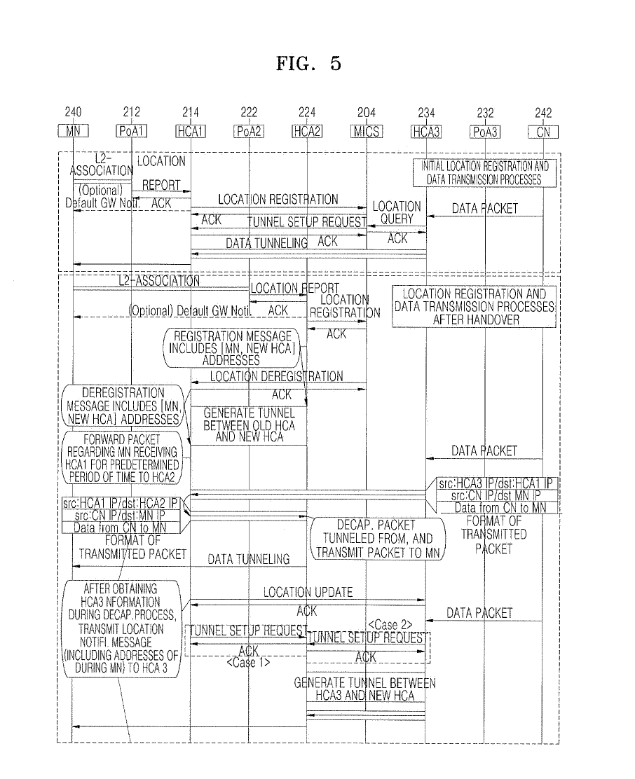

FIG. 5 is a flowchart of location registration and data transmission processes for supporting fast handover of a mobile node, according to another embodiment.

Referring to FIGS. 2 and 5, “initial location registration and data transmission processes” according to the present embodiment is the same as that of FIG. 2, and thus its detailed description will not be repeated. Hereinafter, “location registration and data transmission processes after handover” of the mobile node will be described.

After the handover, the MN 240 performs a L2-association process with the PoA #2 222, and the PoA #2 222 that obtains the L2 address of the MN 240 during the L-2 association process transmits the location report message including the L2 address of the MN 240 to the HCA #2 224.

The HCA #2 224 that receives the location report message from the PoA #2 222 transmits a location report acknowledgment to the PoA #2 222, and transmits a location registration message to the MICS 204.

The MICS 204 that receives the location registration message from the HCA #2 224 searches the GBT of the MICS 204, changes a HCA IP address mapped to the L2 address of the MN 240 from the HCA #1 214 to the HCA #2 224, and transmits a location registration acknowledgment to the HCA #2 224. In this regard, the location registration acknowledgment includes the IP address of the MN 240 and the IP address of the HCA #1 214 where the MN 240 is located prior to the handover.

The HCA #2 224 that receives the location registration acknowledgment from the MICS 204 sets up a tunnel towards the HCA #1 214 by using the IP address of the HCA #1 214 and the IP address of the MN 240, which are included in the location registration acknowledgment from the MICS 204.

After transmitting the location registration acknowledgment to the HCA #2 224, the MICS 204 transmits to the HCA #1 214 the location deregistration message including the IP address of the HCA #2 224 where the MN 240 performs the handover.

When the HCA #1 214 receives the location deregistration message from the MICS 204, the HCA #1 214 sets up a tunnel towards the HCA #2 224 where the MN 240 is presently located by using the IP address of the MN 240 and the IP address of the HCA #2 224, which are included in the location deregistration message.

When the data packet from the CN 242 arrives at the HCA #3 234, the HCA #3 234 performs IP-in-IP encapsulation on the data packet, and forwards the data packet to the HCA #1 214 in which the tunnel interface with respect to the MN 240 is set up.

When the HCA #1 214 receives the data packet encapsulated by the HCA #3 234, the HCA #1 214 decapsulates the data packet, and checks a destination address of the data packet. If it is determined that deregistration has already been performed on the MN 240 corresponding to the destination address of the data packet and that the MN 240 has moved to another HCA, the data packet received is forwarded to the MN 240 through the tunnel set-up from the HCA #1 214 to the HCA #2 224. In this regard, an example of the data packet forwarded is illustrated in FIG. 5.

When the HCA #2 224 receives the data packet through the tunnel, the HCA #2 224 decapsulates the data packet, checks a destination address of the data packet, and forwards the data packet to the MN 240.

The HCA #1 214 transmits to the HCA #3 234 the location update message including an address of the HCA #2 224 to which the MN moves, wherein the address of the HCA #2 224 is obtained during the deregistration process.

The HCA #3 234 that receives the location update message from the HCA #1 214 changes tunnel information regarding the MN 240 from the HCA #1 214 to the HCA #2 224, and transmits the data packet received by the MN 240 by the tunnel between the HCA #1 214 and the HCA #2 224.

After transmitting the location update message to the HCA #3 234, the HCA #1 214 transmits the tunnel setup request message including the IP address of the HCA #3 234 to the HCA #2 224 so as to request the HCA #2 224 to set up a tunnel towards the HCA #3 234 (CASE 1). Alternatively, after receiving the location update message, the HCA #3 234 recognizes an address of the HCA #2 224, included in the location update message, and transmits the tunnel setup request message to the HCA #2 224 so as to request the HCA #2 224 to set up a tunnel towards the HCA #3 234 (CASE 2).

A tunnel between the HCA #1 214 and the HCA #2 224 is maintained for a predetermined period of time, and then is automatically released by timeout.

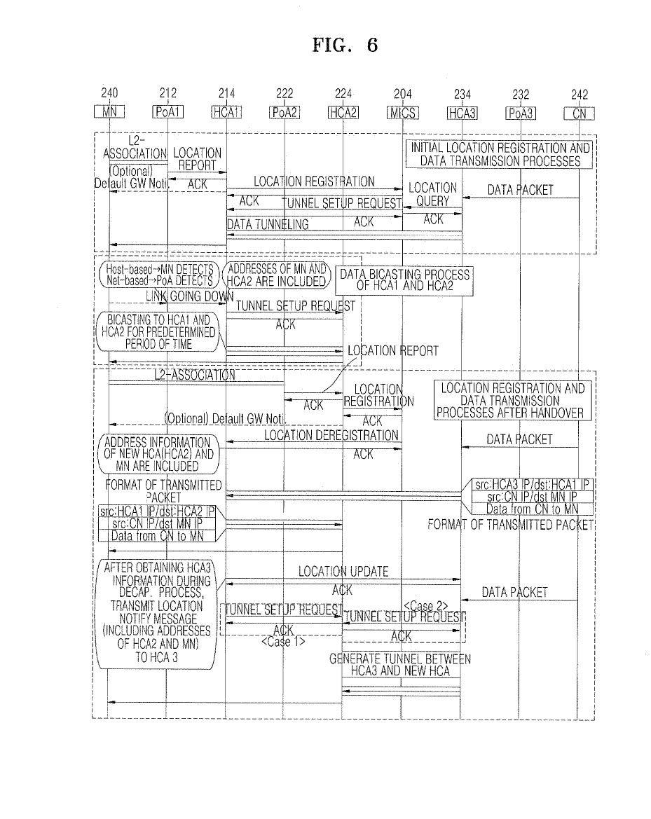

FIG. 6 is a flowchart of a fast handover method using data bicasting, according to an embodiment.

Referring to FIGS. 2 and 6, “initial location registration and data transmission processes” of the MN 240 according to the present embodiment is the same as that of FIG. 2, and thus its detailed description will not be repeated. Hereinafter, the data bicasting from the HCA #1 214 to the HCA #2 224 will be described.

Just before the handover of the MN 240, a link going down message is transmitted from the PoA #1 212 to the HCA #1 214. When host-based mobility is provided, the link going down message may be generated in the MN 240. When network-based mobility is provided, the PoA #1 212 may check a mobility state of the MN 240 and may generate the link going down message.

The HCA #1 214 that receives the link going down message transmits the tunnel setup request message regarding the MN 240 to the HCA #2 224 by using the IP address of the MN 240 and the IP address of the HCA #2 224 to which the MN 240 is to move, which are included in the link going down message.

The HCA #2 224 generates a tunnel to the HCA #1 214 by using the IP address of the HCA #1 214 and the IP address of the MN 240, which are included in the tunnel setup request message, and transmits a tunnel setup request acknowledgment to the HCA #1 214.

After receiving the tunnel setup request acknowledgment, the HCA #1 214 generates a tunnel for the MN 240 with respect to the HCA #2 224. The HCA #1 214 forwards the data packet received by the MN 240 that is located in a domain of the HCA #1 214, and simultaneously forwards the data packet to the HCA #2 224 through the tunnel between the HCA #1 214 and the HCA #2 224.

The HCA #2 224 forwards the data packet received from the HCA #1 214 through the tunnel to the MN 240 through PoA #2 222. The tunnel between the HCA #1 214 and the HCA #2 224 is maintained for a predetermined period of time, and then is automatically released by timeout.

The “location registration and data transmission processes after handover” of the MN 240 will be described.

After the handover, the MN 240 performs a L2-association process with the PoA #2 222, and the PoA #2 222 that obtains the L2 address of the MN 240 during the L2-association process transmits the location report message including the L2 address of the MN 240 to the HCA #2 224.

The HCA #2 224 that receives the location report message from the PoA #2 222 transmits a location report acknowledgment to the PoA #2 222, and transmits a location registration message to the MICS 204.

The MICS 204 that receives the location registration message from the HCA #2 224 searches the GBT of the MICS 204, changes a HCA IP address mapped to the L2 address of the MN 240 from the HCA #1 214 to the HCA #2 224, and transmits a location registration acknowledgment to the HCA #2 224.

After transmitting the location registration acknowledgment to the HCA #2 224, the MICS 204 transmits to the HCA #1 214 the location deregistration message including the IP address of the HCA #2 224 on which the MN 240 performs the handover.

When the HCA #1 214 receives the location deregistration message from the MICS 204, the HCA #1 214 stops forwarding the data packet regarding the MN 240 to the PoA #1 212, and keeps transmitting the data packets through the tunnel.

The HCA #1 214 transmits to the HCA #3 234 the location update message including an address of the HCA #2 224 to which the MN 240 moves and obtained during the deregistration process.

The HCA #3 234 that receives the location update message from the HCA #1 214 changes tunnel information regarding the MN 240 from the HCA #1 214 to the HCA #2 224, and then transmits the data packet regarding the MN 240, which is received after the change of tunnel information, to the HCA #2 224 by the tunnel.

The HCA #1 214 transmits the tunnel setup request message including the IP address of the HCA #3 234 to the HCA #2 224 so as to request the HCA #2 224 to set up a tunnel towards the HCA #3 234 (CASE 1). Alternatively, after receiving the location update message, the HCA #3 234 recognizes an address of the HCA #2 224, included in the location update message, and transmits the tunnel setup request message to the HCA #2 224 so as to request the HCA #2 224 to set up a tunnel towards the HCA #3 234 (CASE 2).

A tunnel between the HCA #1 214 and the HCA #2 224 is maintained for a predetermined period of time, and then is automatically released by timeout.

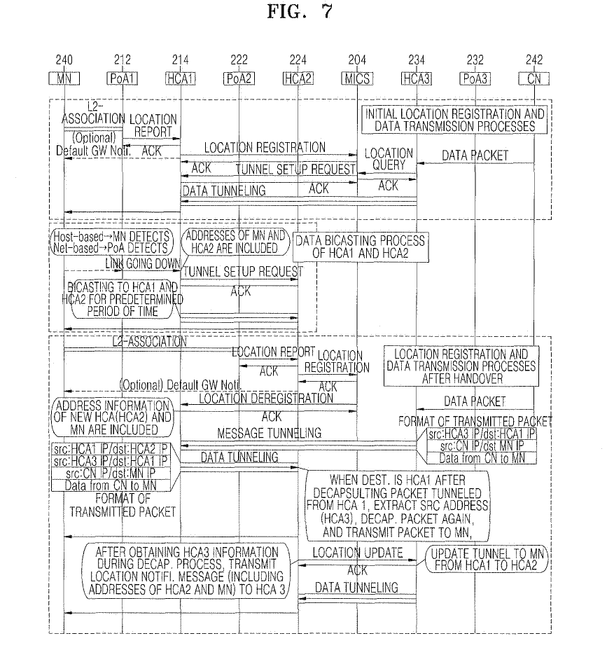

FIG. 7 is a flowchart of a fast handover method using data bicasting, according to an embodiment.

Referring to FIGS. 2 and 7, “initial location registration and data transmission processes” of the MN 240 according to the present embodiment is the same as that of FIG. 2, and thus its detailed description will not be repeated. Hereinafter, the data bicasting from the HCA #1 214 to the HCA #2 224 will be described.

Just before the handover of the MN 240, a link going down message is transmitted from the PoA #1 212 to the HCA #1 214. When host-based mobility is provided, the link going down message may be generated in the MN 240. When network-based mobility is provided, the PoA #1 212 may check a mobility state of the MN 240 and may generate the link going down message.

The HCA #1 214 that receives the link going down message from the PoA #1 212 transmits the tunnel setup request message regarding the MN 240 to the HCA #2 224 by using the IP address of the MN 240 and the IP address of the HCA #2 224 to which the MN 240 is to move, which are included in the link going down message.

The HCA #2 224 generates a tunnel to the HCA #1 214 by using the IP address of the HCA #1 214 and the IP address of the MN 240, which are included in the tunnel setup request message, and transmits a tunnel setup request acknowledgment to the HCA #1 214.

After receiving the tunnel setup request acknowledgment, the HCA #1 214 generates a tunnel for the MN 240 with respect to the HCA #2 224. The HCA #1 214 forwards the data packet received by the MN 240 that is located in a domain of the HCA #1 214, and simultaneously forwards the data packet to the HCA #2 224 through the tunnel between the HCA #1 214 and the HCA #2 224.

The HCA #2 224 forwards the data packet received from the HCA #1 214 through the tunnel to the MN 240 through the PoA #2 222. The tunnel between the HCA #1 214 and the HCA #2 224 is maintained for a predetermined period of time, and then is automatically released by timeout.

The “location registration and data transmission processes after handover” of the MN 240 will be described.

After the handover, the MN 240 performs a L2-association process with the PoA #2 222, and the PoA #2 222 that obtains the L2 address of the MN 240 during the L2-association process transmits the location report message including the L2 address of the MN 240 to the HCA #2 224.

The HCA #2 224 that receives the location report message from the PoA #2 222 transmits a location report acknowledgment to the PoA #2 222, and transmits a location registration message to the MICS 204.

The MICS 204 that receives the location registration message from the HCA #2 224 searches the GBT of the MICS 204, changes a HCA IP address mapped to the L2 address of the MN 240 from the HCA #1 214 to the HCA #2 224, and transmits a location registration acknowledgment to the HCA #2 224. After transmitting the location registration acknowledgment to the HCA #2 224, the MICS 204 transmits the location deregistration message to the HCA #1 214.

When the HCA #1 214 normally receives the location deregistration message from the MICS 204, the HCA #1 214 transmits a location deregistration acknowledgment to the MICS 204 in response to the location deregistration message.

When a data packet from the CN 242 arrives at the HCA #3 234, the HCA #3 234 performs IP-in-IP encapsulation on the data packet, and forwards the data packet to the HCA #1 214 in which the tunnel interface with respect to the MN 240 is set up.

When the HCA #1 214 receives the data packet encapsulated by the HCA #3 234, the HCA #1 214 decapsulates the data packet, and checks a destination address of the data packet. If it is determined that deregistration has already been performed on the MN 240 corresponding to the destination address of the data packet and that the MN 240 has moved to another HCA, the data packet received regarding the MN 240 is forwarded through a tunnel set up from the HCA #1 214 to the HCA #2 224.

In this regard, a format of the data packet forwarded is a format in which the encapsulated data packet received from the HCA #3 234 is encapsulated to include a header having an IP address of the HCA #2 224 as a destination IP address and an IP address of the HCA #1 214 as a source IP address, as illustrated in FIG. 7.

When the HCA #2 224 receives the data packet through the tunnel, the HCA #2 224 decapsulates the data packet, and checks the destination IP address of the data packet. If the destination IP address of the data packet corresponds the HCA #1 214 where the tunnel is generated, the HCA #2 224 decapsulates the data packet again, and forwards the data packet to the MN 240.

The HCA #2 224 may obtain the IP address of the HCA #3 234 during the decapsulation process on the data packet transmitted to the HCA #2 224 through the HCA #3 234 and the HCA #1 214, and may transmit the location update message including the IP address of the MN 240 and the IP address of the HCA #2 224 to the HCA #3 234 by using the IP address of the HCA #3 234.

The HCA #3 234 that receives the location update message from the HCA #2 224 changes tunnel information regarding the MN 240 from the HCA #1 214 to the HCA #2 224, and then transmits the data packet regarding the MN 240, which is received after the change of tunnel information, to the HCA #2 224 by the tunnel.

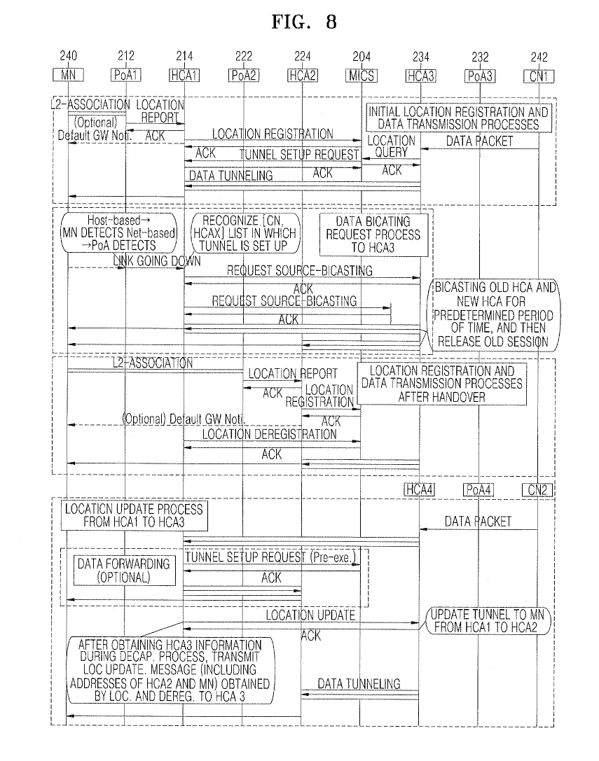

FIG. 8 is a flowchart of a fast handover method using data bicasting, according to another embodiment.

Referring to FIGS. 2 and 8, “initial location registration and data transmission processes” of the MN 240 according to the present embodiment is the same as that of FIG. 2, and thus its detailed description will not be repeated. Hereinafter, the data bicasting from the HCA #1 214 to the HCA #2 224 will be described.

Just before the handover of the MN 240, a link going down message is transmitted from the PoA #1 212 to the HCA #1 214. When host-based mobility is provided, the link going down message may be generated in the MN 240. When network-based mobility is provided, the PoA #1 212 may check a mobility state of the MN 240 and may generate the link going down message.

The HCA #1 214 that receives the link going down message transmits a source bicast request message regarding the MN 240 to a correspondent HCA where a tunnel to the HCA #1 214 is currently set up. The source bicast request message includes the IP address of the MN 240 and the IP address of the HCA #2 224 to which the MN 240 is to move.

The HCA #1 214 transmit the tunnel setup request message to the HCA #2 224 so that tunnel interfaces maintained in the HCA #1 214 is set up in the HCA #2 224. The correspondent HCA receiving the source bicast request message keeps forwarding the data packet regarding the MN 240 to the HCA #1 214, and simultaneously sets up a tunnel to the HCA #2 224 to which the MN 240 is to move so as to bicast the data packet regarding the MN 240.

The “location registration and data transmission processes after handover” of the MN 240 will be described.

After the handover, the MN 240 performs a L2-association process with the PoA #2 222, and the PoA #2 222 that obtains the L2 address of the MN 240 during the L2-association process transmits the location report message including the L2 address of the MN 240 to the HCA #2 224.

The HCA #2 224 that receives the location report message transmits a location report acknowledgment to the PoA #2 222, and transmits a location registration message to the MICS 204.

The MICS 204 that receives the location registration message from the HCA #2 224 searches the GBT of the MICS 204, changes a HCA IP address mapped to the L2 address of the MN 240 from the HCA #1 214 to the HCA #2 224, and transmits a location registration acknowledgment to the HCA #2 224.

After transmitting the location registration acknowledgment to the HCA #2 224, the MICS 204 transmits the location deregistration message to the HCA #1 214. When the HCA #1 214 normally receives the location deregistration message from the MICS 204, the HCA #1 214 transmits a location deregistration acknowledgment to the MICS 204 in response to the location deregistration message.

After these operations, “a location update process from the HCA #1 214 to the HCA #3 234” is performed.

When a data packet from the CN 242 arrives at the HCA #3 234, the HCA #3 234 performs IP-in-IP encapsulation on the data packet, and forwards the data packet to the HCA #1 214 in which the tunnel interface with respect to the MN 240 is set up.

When the HCA #1 214 receives the data packet encapsulated, the HCA #1 214 decapsulates the data packet, and checks a destination address of the data packet. If it is determined that deregistration has already been performed on the MN 240 corresponding to the destination address of the data packet and that the MN 240 has moved to another HCA, the data packet received regarding the MN 240 is forwarded through a tunnel set up from the HCA #1 214 to the HCA #2 224.

The HCA #1 214 transmits to the HCA #3 234 the registration update message including an address of the HCA #2 224 and obtained during the deregistration process.

The HCA #3 234 that receives the location update message from the HCA #1 214 stops forwarding the data packet regarding the MN 240 to the PoA #1 212, deletes the tunnel, and then transmits the data packet regarding the MN 240 only to the HCA #2 224.

According to the presented embodiments, when the core network 200 supports multi-protocol label switching (MPLS) technology, the location registration, location deregistration and location query signaling between the HCAs #1, #2 and #3 212, 222 and 232 and the MICS 204 are transmitted through a label switched path (LSP) only for signaling set-up between the HCAs #1, #2 and #3 212, 222 and 232 and the MICS 204, and thus the mobility signaling may be transmitted separately from data packet forwarding so as to be stably and transmitted fast.

In addition, the location update request and tunnel setup request between the HCAs #1, #2 and #3 212, 222 and 232 may be transmitted through the label switched path (LSP) only for signaling set-up between the HCAs #1, #2 and #3 212, 222 and 232. The data packet forwarding between the HCAs #1, #2 and #3 212, 222 and 232 uses the label switched path (LSP) set-up between the HCAs #1, #2 and #3 212, 222 and 232, thereby ensuring quality of service (QoS) of a mobile data packet.

According to the present invention, fast handover may be provided to MNs by using the location update function between HCAs and the data bicasting from an old HCA performing handover to a new HCA. By such behavior properties, a service interruption time during the handover of an MN is reduced, and data packet loss may be reduced.

The invention may also be embodied as computer readable code on a computer readable recording medium. The computer readable recording medium is any data storage device that may store data which may be thereafter read by a computer system. Examples of the computer readable recording medium include read-only memory (ROM), random-access memory (RAM), CD-ROMs, magnetic tapes, floppy disks, optical data storage devices, etc. The computer readable recording medium may also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A handover method in an apparatus for managing location information of a mobile node, the handover method comprising:
receiving a binding update request message;
updating binding information of the mobile node by using a temporary location identifier that is newly assigned; and
transmitting an acknowledgment in response to the binding update request message.

2. The handover method of claim 1, further comprising, after receiving the binding update request message, checking whether the binding update request message is to handle a handover situation, or initial connection establishment of the mobile node.

3. The handover method of claim 1, wherein the updating comprises updating the temporary location identifier to an identifier that is newly assigned in the mobile node, in the binding information indicating a mapping relationship between a persistent location identifier that is not changed when the mobile node moves to another region and the temporary location identifier that is changed when the mobile node moves to another region.

4. The handover method of claim 1, wherein the temporary location identifier comprises an Internet protocol (IP) address.

5. A handover method in a relaying apparatus of a mobile communication network, the handover method comprising:
if receiving notification of a layer 2 (L2) association with a mobile node, transmitting a binding update request message for the mobile node;
if receiving an acknowledgment in response to the binding update request message, transmitting a tunnel update message regarding the mobile node; and
receiving an acknowledgment in response to the tunnel update message.

6. The handover method of claim 5, wherein the transmitting of the binding update request message comprises: transmitting the binding update request message to an entity managing location information of the mobile node.

7. The handover method of claim 5, wherein the transmitting of the tunnel update message comprises: transmitting the tunnel update message to an entity L2-associated with the mobile node.

8. A handover method in a relaying apparatus of a mobile communication network, the handover method comprising:
if recognizing a temporary location identifier regarding a correspondent node of the mobile node, transmitting a message regarding a change in an endpoint of a data tunnel towards the mobile node; and
receiving an acknowledgment in response to the message.

9. The handover method of claim 8, wherein the transmitting of the message comprises: transmitting the message to an entity that presently controls another endpoint of the data tunnel which is associated by the correspondent node.

10. The handover method of claim 8, wherein the transmitting of the message comprises: if receiving a tunnel update message from an entity managing location information of the mobile node, transmitting the message.

11. The handover method of claim 8, further comprising: if receiving the acknowledgment, transmitting an acknowledgment in response to a tunnel update message to an entity managing location information of the mobile node.

12. A handover method in a relaying apparatus of a mobile communication network, the handover method comprising:
receiving a temporary location identifier of a correspondent node from an entity where a mobile node is previously located before the mobile node moves;
transmitting a message regarding a change in an endpoint of a data tunnel towards the mobile node; and
receiving an acknowledgment in response to the message.

13. The handover method of claim 12, wherein the transmitting of the message comprises: transmitting the message to an entity that presently controls another endpoint of the data tunnel which is associated by the correspondent node.

14. A mobility supporting method of a mobile node when the mobile node performs handover from a first access network comprising a first handover control agent (HCA) to a second access network comprising a second HCA, in a system comprising handover control agents associating access networks with a core network, and a mobility information control system (MICS) located in the core network, the mobility supporting method comprising:
setting-up a tunnel towards the first HCA, based on an address of the first HCA of a message received from the MICS, wherein the setting-up is performed by the second HCA;
setting-up a tunnel towards the second HCA, based on an address of the second HCA of a deregistration message received from the MICS, wherein the setting-up is performed by the first HCA;
transmitting a location update message comprising an address of the mobile node and the address of the second HCA to a third HCA of a third access network to which a correspondent node belongs, wherein the transmitting is performed by the first HCA or the second HCA;
changing tunnel information regarding the mobile node from the first HCA to the second HCA, wherein the changing is performed by the third HCA; and
releasing a tunnel between the first HCA and the second HCA after a predetermined period of time by timeout.

15. The mobility supporting method of claim 14, wherein the transmitting of the location update message comprises:
receiving a packet of a correspondent node, which is IP-in-IP encapsulated, from the first HCA through the tunnel, wherein the receiving is performed by the second HCA;
recognizing an address of a third HCA of a third access network to which the correspondent node belongs through decapsulation of the packet, wherein the recognizing is performed by the second HCA; and
transmitting a location update message comprising an address of the mobile node and an address of the second HCA, wherein the transmitting is performed by the second HCA.

16. The mobility supporting method of claim 14, wherein the transmitting of the location update message comprises:
receiving a packet of a correspondent node, which is IP-in-IP encapsulated, wherein the receiving is performed by the first HCA;
recognizing an address of a third HCA to which the correspondent node belongs through decapsulation of the packet, wherein the recognizing is performed by the first HCA; and
transmitting a location update message comprising an address of the first HCA and an address of the second HCA to the third HCA.

17. A mobility supporting method of a mobile node when the mobile node performs handover from a first access network comprising a first handover control agent (HCA) to a second access network comprising a second HCA, in a system comprising handover control agents associating access networks with a core network, and a mobility information control system (MICS) located in the core network, the mobility supporting method comprising:
transmitting a location report message comprising an address of the mobile node, wherein the transmitting is performed by the second HCA;
receiving a deregistration message comprising an address of the second HCA from the MICS, wherein the receiving is performed by the first HCA;
if receiving a packet from a third HCA of a second access network to which a correspondent node belongs, transmitting a location update message comprising an address of the second HCA, wherein the transmitting is performed by the first HCA; and
changing tunnel information regarding the mobile node from the first HCA to the second HCA, wherein the changing is performed by the third HCA.

18. A mobility supporting method of a mobile node, in a system comprising handover control agents associating access networks with a core network, and a mobility information control system (MICS) located in the core network, the mobility supporting method comprising:
setting-up a tunnel to a second handover control agent (HCA), wherein the setting-up is performed by a first HCA receiving a link going down message generated when the mobile node performs handover from a first access network comprising the first HCA to a second access network comprising the second HCA;
forwarding a packet, received regarding the mobile node to the mobile node located in the first access network, to the mobile node located in the first access network, and forwarding the packet to the second HCA through the tunnel, wherein the forwarding is performed by the first HCA;
forwarding the packet received from the tunnel to a point of attachment (PoA) of the second access network through the tunnel; and
automatically releasing the tunnel after a predetermined period of time by timeout.
